(19) United States
(12) Patent Application Publication
(10) Pub. No.: US 2005/0071361 A1
(43) Pub. Date: Mar. 31, 2005

(54) System and method for associating a device with a user

(75) Inventors: Mark Bernard Hettish, Cary, NC (US); Jeff Blohm, Portola Valley, CA (US)

Correspondence Address: Siemens Corporation;Attn: Elsa Keller, Legal Administrator, Intellectual Property Department, 170 Wood Avenue South, Iselin, NJ, 08830, US

(73) Assignee: Siemens Information and Communication Networks, Inc.

(21) Appl. No.: 10/674,013

(22) Filed: Sep. 29, 2003

(51) Int. Cl. G06F 17/00

(52) U.S. Cl. 707/102

(57) ABSTRACT

Embodiments provide a system, methods, apparatus, means, and computer program code for associating a device with user.

### FIELD

The present invention relates to a method, system, means and computer code for associating a device with a user.

### BACKGROUND

A person in a multi-media or multi-channel communications system may have or use multiple devices, such as a telephone, personal digital assistant (PDA), computer, etc. Thus, the person may be represented by or associated with the different types of devices. For example, in a SIP (Session Initiation Protocol) system, a user may have SIP devices and applications such as telephones and client applications that are registered with the system. However, the user also may want to use non-registered devices such as a cellular telephone, pager, email device, etc. when using or accessing system features.

As such, there is a need for a system, method, apparatus, means, and computer program code for allowing and enabling non-registered devices to be associated with a system and a specific identity or identities within that system.

### SUMMARY

Embodiments provide a system, method, apparatus, means, and computer program code for associating a device with a user in a system. More specifically, embodiments provide a system, means, computer code, and methods that allow and enable one or more devices used by an identity (e.g., an individual or group) to be associated with the identity in a system. The system may allow other devices to be registered with the system so that applications in the system are “aware” of or can “see” the devices. In addition, identities may still use the associated devices to access and use features of the system and applications operating in the system may be aware of their availability or other device context even though the associated devices are not registered with the system.

Additional advantages and novel features shall be set forth in part in the description that follows, and in part will become apparent to those skilled in the art upon examination of the following or may be learned by the practice of the invention.

According to embodiments, a method may include configuring a first device as an associated device in a system; receiving information regarding a second device from a device management component, said second device being registered with said system; and maintaining information regarding said first device and said second device. Other embodiments may include means, systems, computer code, etc. for implementing some or all of the elements of the methods described herein.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE FIGURES

The accompanying drawings, which are incorporated in and form a part of the specification, illustrate embodiments of the invention.

FIG. 1 is a block diagram of a system according to some embodiments;

FIG. 2 is another block diagram according to some embodiments;

FIG. 3 is a flowchart of a method in accordance with some embodiments; and

FIG. 4 is a block diagram of a server that may implement one or more of the components of FIG. 1 and/or one or more elements of the methods described here.

### DESCRIPTION

Applicants have recognized that there is a market opportunity for systems, means, computer code, and methods that allow and enable one or more devices used by an identity (e.g., an individual or group) to be associated with the identity in a system. The system may allow other devices to be registered with the system so that applications in the system are “aware” of or can “see” the devices. Typically, information regarding such registered devices is maintained in one or more registration databases. Associated devices may not be registered with the system and, as a result, information regarding the associated devices may not be stored in the registration database(s). However, identities may still want to use the associated devices to access and use features of the system and may want applications operating in the system to be aware of their availability or other device context even though the devices are not registered with the system.

In some embodiments an identity may be or include an individual person or a group of people. An identity context for the identity could be a state of “in meeting.” “on vacation,” “in the office,” “out of the office,” “roaming,” “offline,” “online,” “unknown,” “on business trip,” “in transit,” “mobile,” etc. Thus, the identify context describes the availability of the identity. An identity context then may allow an identity to have an overall state that describes work or non-work state that that the identity is in.

An identity may have one or more associated devices. For example, a person may have an associated office telephone, a home telephone, a cellular telephone, computer, personal digital assistant (PDA), etc. Each device may have an associated device context. For example, the person's office telephone may be busy, set to “do not disturb,” automatic call forwarding, offline, etc. Context for a device may describe the work or non-work state, and/or the availability or non-availability state, that the device is in. In some embodiments, potential device contexts may include “available,” “non-available,” “busy,” “away,” “unknown,” “partially available” (e.g., a device may be “busy” on a voice channel but available on an instant messaging channel), “be right back,” “present,” not present,” etc. In some embodiments, different applications may be used to set, monitor or change a device context for a device. For example, software operating on a computer may allow a user to indicate manually or automatically that the computer is unavailable for email, instant messaging, file transfer or other communications at the current time, at a specific later time, during a time range, etc. As another example, a wireless and instant messaging capable PDA may be considered as having a device context as “available” by a presence and availability service when the PDA is online and a device context of “unavailable” by the presence and availability service when the PDA is offline.

In a system using the Session Initiation Protocol (SIP), an identity's devices may be registered with a SIP compliant device or application. However, the identity may have other associated devices that are not registered with the SIP compliant device or application, such as cellular telephones, pagers, SMD devices, email devices, etc. that the identity wants to use with or as part of the system. However, if a device does not register in the SIP environment for the system, the underlying SIP infrastructure for the system does not see or know about the device, the device may not be in any SIP-based presence and availability service that might be part of the system, and the device may not be seen or known by applications running in the SIP system. For example, in a SIP-based system, assume an identity has an email account established with an email device (e.g., a PDA), a registered SIP telephone, and an unregistered cellular telephone. If the identity's SIP telephone is offline, the identity may be willing or able to take calls on the cellular telephone and receive email on the email device. However, since only the SIP telephone is registered in the SIP system, an application monitoring or showing availability of the identity would indicate that the identity could not be contacted. Yet in reality, the identity may be contacted by email and via the cellular telephone.

While the examples discussed herein will be based on SIP, other or different protocols also may be used. SIP is an application protocol that allows endpoints on the Internet or other networks to discover one another in order to exchange context information about a session they would like to share. Common forms of communication that may be established using SIP include Internet telephony, instant messaging, video, Internet gaming and other forms of real-time communications. SIP also allows a multi-service protocol capable of initiating sessions involving different forms of real-time communications simultaneously.

For purposes of further discussion, devices may be registered with respect to a particular identity in a system and the system's underlying protocol infrastructure. Devices that are not registered in the system 100 with respect to a particular identity and underlying protocol infrastructure for a system are referred to as associated devices. For example, in a SIP system (e.g., a system using a SIP underlying infrastructure), associated devices may be unregistered SIP devices or unregistered non-SIP devices while registered devices will be SIP devices that are registered with the SIP system to operate in the SIP environment. The registered devices may register with a registration server in the SIP system. During the registration, each of the registered devices is registered with respect to an identity (e.g., a specific person or user). The registration server may maintain a database of information regarding one or more registered devices. Thus, the registered devices will show up in SIP registration database as being assigned to one or more users and can be seen by applications operating in the SIP environment. In contrast, the associated devices do not register with the registration server and, as a result, will not show up in the SIP registration databases.

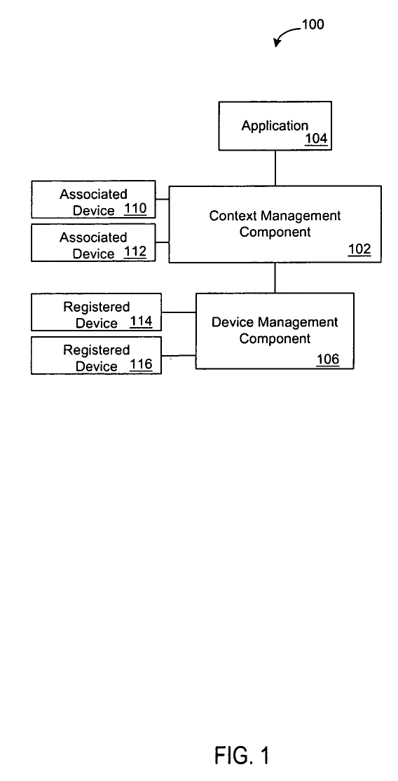

Now referring to FIG. 1, an exemplary system 100 is illustrated according to some embodiments. The system 100 includes a context management component 102 (sometimes referred to or including a context agent) that may be connected to or in communication with an application 104 and a device management component 106. The system 100 may include other hardware and/or software components (e.g., gateways, proxy servers, registration servers, presence servers, redirect servers, databases, applications), such as, for example, hardware and software used to support a SIP or other protocol based infrastructure for the system 100 and allow registration of SIP devices in the system 100.

User devices, such as associated user devices 110, 112, may be connected to or in communication with the context management component 102. Similarly, user devices, such as registered user devices 114, 116, may be connected to or in communication with the device management component 106. The device management component 106 may enable the registered devices 114, 116 to register with the system 100 or otherwise may help facilitate their registration with the system 100.

In some embodiments, a user device may be or include such things as telephones, cellular telephones, PDAs, computers, etc. For example, the registered user devices 114, 116, may be personal computers implementing the Windows XP™ operating system and the Windows Messenger™ instant messenger system. In addition, the user devices 114, 116 may include telephony and other multimedia messaging capability using, for example, peripheral cameras, Webcams, microphones and speakers (not shown) or peripheral telephony handsets, such as the Optipoint™ handset available from Siemens Corporation.

In some embodiments, the context management component 102 may monitor the identity context of one or more users. In some embodiments, the context management component 102 may provide or include an application interface that supports identity context, device context, device presence, and/or other functions. Applications may monitor, access and/or query the context management component 102 for identity context and/or device context information.

In some embodiments, the device management component 106 may provide device context and/or other information regarding one or more registered devices to the context management component 102. The context management component 102 may store or otherwise maintain device context and/or information regarding the registered devices. In addition, the context management component 102 may allow associated devices to act like registered devices for purposes of the application 104. That is, while the associated user devices 110, 112 may not be known or seen by the device management component 106, which can only communicate with or see registered devices, the application 104 can see the registered devices 114, 116 since they are registered in the system 100, and the associated devices 110, 112 via operation or use of the context management component 102. Thus, the context management component 102 allows the associated devices 110, 112 to act like registered devices for purposes of the application 104. The context management component 102 may store or otherwise maintain device context and/or other information regarding the associated devices.

In some embodiments, the context management component 102 may provide information regarding one or more registered devices and/or one or more associated devices to the application 104 upon request or query, periodically, or in accordance with some other plan, algorithm or procedure. The context management component 102 may be implemented in hardware and/or software operating on one or more servers, computer systems, host or mainframe computers, workstations, etc. In some embodiments the context management component 102 may be operating on some or all of the same device(s) as other components in the system 100.

In some embodiments, the application 104 may be or include an application that uses, collects, refers to, etc. information regarding the identity context of one or more identities and/or the device context for one or more devices registered or associated with the identities. For example, an application may be or include software that allows users to provide information regarding their availability, location, etc. In some embodiments, a user device, server, host or mainframe computer, workstation, etc. may include an identity context oriented application or have one operating or residing on it.

In some embodiments, the application 104 may be implemented in hardware and/or software operating on one or more servers, computer systems, host or mainframe computers, workstations, etc. In some embodiments the application 104 may be operating on some or all of the same device(s) as other components in the system 100 and/or may be able to communicate directly or indirectly with the device management component 106.

The device management component 106 may be or include an application that communicates with or is connected to one or more registered devices (e.g., devices 114, 116), allows devices to register with the system 100 or helps facilitate their registration, etc. For example, in a SIP environment, the devices 114, 116 may be registered with the system 100 and may show up or be described in registration databases as being assigned to particular users. In addition, the devices 114, 116 may be known to the device management component 106.

In some embodiments, the device management component 106 may be or include a presence and availability service that monitors the presence and availability of the devices 114, 116. That is, the presence and availability service monitors the device context of one or more devices. The context management component 102 may register with the presence and availability service and receive device context and/or other information from the presence and availability service regarding the registered devices 114, 116. The context management component 102 may store or otherwise maintain information regarding the registered devices 114, 116 and/or the associated devices 110, 112.

The device management component 106 may be implemented in software operating or resident on one or more servers, computer systems, host or mainframe computers, workstations, etc. In some embodiments the device management component may be operating on some or all of the same device(s) as other components in the system 100 and/or communicate directly with one or more applications.

In some embodiments, the device management component 106 may provide device context information to applications or the context management component upon request, periodically, or in accordance with some other plan or procedure. In some embodiments, the device management component 106 may implement an instant messaging system. For example, the instant messaging system may be embodied as Microsoft Windows Messenger™ software or other instant messaging system.

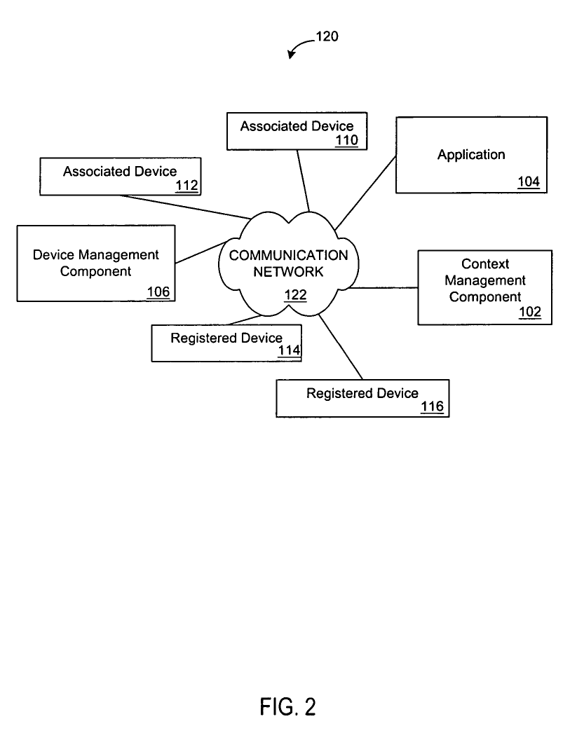

In some embodiments, one or more of the components of the system 100 may be connected or in communication with each other via a communication network. For example, now referring to FIG. 2, a system 120 including the components of the system 100 is illustrated, wherein some or all of the components are in communication via a network 122. The network 122 may be or include the Internet, the World Wide Web, a local area network, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

Process Description

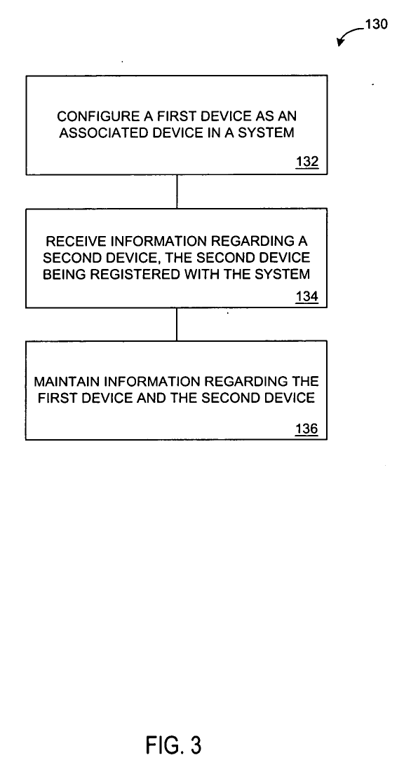

Reference is now made to FIG. 3, where a flow chart 132 is shown which represents the operation of a first embodiment. The particular arrangement of elements in the flow chart 132 is not meant to imply a fixed order to the elements; embodiments can be practiced in any order that is practicable.

Processing begins at 132 during which the context management component 102 configures one or more associated devices (e.g., the associated devices 110, 112) such that the associated devices are associated, but not registered, with the system 100. For example, for a SIP system, a device may not be registered with the system and/or with a particular identity for use in the SIP system, but may become an associated device for the identity even though the device is not registered with the SIP system.

In some embodiments of 132, an application (e.g., the application 104 or an application operating on a device to be configured) may send one or more calls to the context management component 102 to configure a device as an associated device or to otherwise provide information to the context management component 102 needed or useful in configuring the device as an associated device. For example, an application may send characteristic data or other information regarding an identity, device name, device type (e.g., PDA, cellular telephone, laptop computer, pager, email device, TTY/TDD device), contact address, device presence (e.g., offline, unknown, online), device context (e.g., offline, unknown, online, busy, do not disturb (DND), forwarding) for a device that is to be an associated device.

The context management component 102 may store or otherwise maintain information regarding the device configured in 132 as an associated device. In some embodiments, the context management component 102 may monitor or detect device context changes for the associated device and report or otherwise provide status and/or changes in such device context for the associated device to one or more applications. In addition, in some embodiments, an application may query the context management component 102 for information regarding one or more associated devices or request that the context management component 102 report or otherwise provide information regarding the one or more associated devices. In some embodiments, an application (e.g., the application 104 or an application operating on an associated device) may send one or more calls to the context management component 102 to change or set device context for the associated devices.

If the context management component 102 is registered with the device management component 106, in some embodiments, the context management component 102 may publish or otherwise provide device context or other information regarding the associated device configured during 132 to the device management component 106. If the device management component 106 is or includes a presence and availability service, the context management component 102 may provide presence and availability information regarding the associated device to the presence and availability service.

During 134, the context management component 102 receives information regarding one or more devices that are registered with the system 100. In some embodiments of 134, the context management component 102 may receive, retrieve or otherwise obtain device context and/or other information regarding the registered device(s) from the device management component 106. In some embodiments, the context management component 132 receives device context information for one or more registered devices.

During 136, the context management component 103 stores or otherwise maintains information regarding the associated device(s) configured in 132 and the registered device(s) for which information is received during 134. In some embodiments, 136 may be or include the context management component 102 storing, keeping or maintaining device context and/or other information regarding one or more registered devices and/or one or more associated devices in one or more local or remote databases, logs, or other electronic resources. In some embodiments, the context management component 102 may provide device context and/or other information regarding one or more registered devices and/or one or more associated devices to the application 104 or another application upon request or query, periodically, or in accordance with some other plan, algorithm or procedure. The application 104 may use, access, query, or work with the context management component 102 to manage, monitor, etc. both registered devices and associated devices.

Server

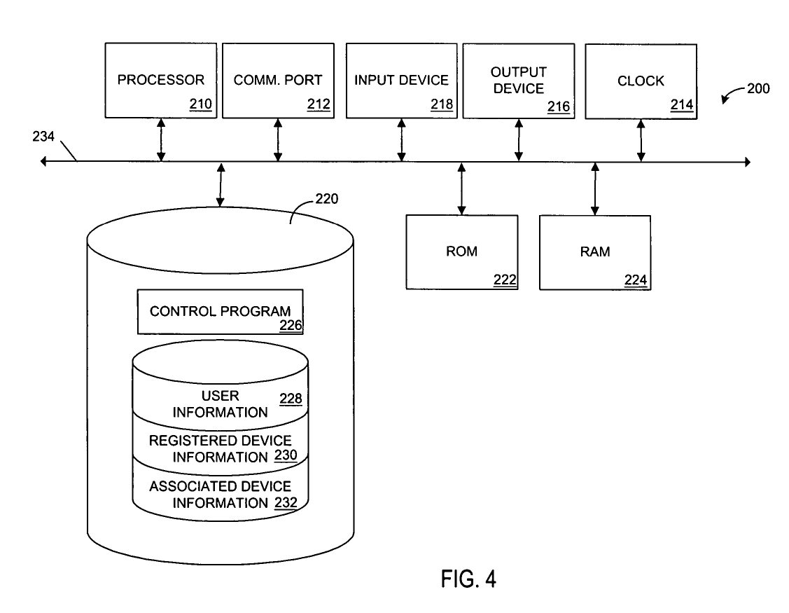

Now referring to FIG. 4, a representative block diagram of a server or controller 200 is illustrated. In some embodiments, the server 200 may include or operate an application, the context management component 102, and/or the device management component 106. The server 200 can comprise a single device or computer, a networked set or group of devices or computers, a workstation, mainframe or host computer, etc. In some embodiments, the server 200 may implement one more elements of the methods disclosed herein.

The server 200 may include a processor, microchip, central processing unit, or computer 210 that is in communication with or otherwise uses or includes one or more communication ports 212 for communicating with user devices and/or other devices. Communication ports may include such things as local area network adapters, wireless communication devices, Bluetooth technology, etc. The server 200 also may include an internal clock element 214 to maintain an accurate time and date for the server 200, create time stamps for communications received or sent by the server 200, etc.

If desired, the server 200 may include one or more output devices 216 such as a printer, infrared or other transmitter, antenna, audio speaker, display screen or monitor, text to speech converter, etc., as well as one or more input devices 218 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 200 may include a memory or data storage device 220 to store information, software, databases, documents, communications, device drivers, etc. The memory or data storage device 220 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 200 also may include separate ROM 222 and RAM 224.

The processor 210 and the data storage device 220 in the server 200 each may be, for example: (i) located entirely within a single computer or other computing device; or (ii) connected to each other by a remote communication medium, such as a serial port cable, telephone line or radio frequency transceiver. In one embodiment, the server 200 may comprise one or more computers that are connected to a remote server computer for maintaining databases.

A conventional personal computer or workstation with sufficient memory and processing capability may be used as the server 200. The server 200 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 210. Equivalent or other processors may be available from Motorola, Inc., AMD, or Sun Microsystems, Inc. The processor 210 also may comprise one or more microprocessors, computers, computer systems, etc.

Software may be resident and operating or operational on the server 200. The software may be stored on the data storage device 220 and may include a control program 226 for operating the server, databases, etc. The control program 226 may control the processor 210. The processor 210 preferably performs instructions of the control program 226, and thereby operates in accordance with the methods described in detail herein. The control program 226 may be stored in a compressed, uncompiled and/or encrypted format. The control program 226 furthermore includes program elements that may be necessary, such as an operating system, a database management system and device drivers for allowing the processor 210 to interface with peripheral devices, databases, etc. Appropriate program elements are known to those skilled in the art, and need not be described in detail herein.

The server 200 also may include or store information regarding users, user devices, contexts, mapping tables, communications, etc. For example, information regarding one or more users may be stored in a user information database 228 for use by the server 200 or another device or entity. Information regarding one or more registered devices may be stored in a context information database 230 for use by the server 200 or another device or entity and information regarding one or more associated devices may be stored in a context mapping information database 232 for use by the server 200 or another device or entity. In some embodiments, some or all of one or more of the databases may be stored or mirrored remotely from the server 200.

According to some embodiments, the instructions of the control program may be read into a main memory from another computer-readable medium, such as from the ROM 222 to the RAM 224. Execution of sequences of the instructions in the control program causes the processor 210 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 210, communication port 212, clock 214, output device 216, input device 218, data storage device 220, ROM 222, and RAM 224 may communicate or be connected directly or indirectly in a variety of ways. For example, the processor 210, communication port 212, clock 214, output device 216, input device 218, data storage device 220, ROM 222, and RAM 224 may be connected via a bus 234.

While specific implementations and hardware/software configurations for the server 200 have been illustrated, it should be noted that other implementations and hardware configurations are possible and that no specific implementation or hardware/software configuration is needed. Thus, not all of the components illustrated in FIG. 4 may be needed for the server 200 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although various embodiments have been described herein, those skilled in the art will note that various substitutions may be made to those embodiments. The invention described in the above detailed description is not intended to be limited to the specific form set forth herein, but is intended to cover such alternatives, modifications and equivalents as can reasonably be included within the spirit and scope of the appended claims.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method, comprising:
configuring a first device as an associated device in a system;
receiving information regarding a second device from a device management component, said second device being registered with said system; and
maintaining information regarding said first device and said second device.

2. The method of claim 1, wherein said configuring a first device as an associated device in a system includes receiving a call from an application to configure said first device as an associated device.

3. The method of claim 1, wherein said receiving information regarding a second device from a device management component includes receiving device context information regarding said second device from said device management component.

4. The method of claim 1, wherein maintaining information regarding said first device and said second device includes maintaining device context information for said first device and device context information for said second device.

5. The method of claim 1, further comprising:
receiving a call from an application to configure said first device.

6. The method of claim 1, further comprising:
receiving a call from an application to set a device context for said first device.

7. The method of claim 6, further comprising:
providing device context information for said first device to said application.

8. The method of claim 1, further comprising:
providing device context information for said first device and said second device to an application.

9. The method of claim 1, further comprising:
providing device context information for said first device to said device management component.

10. The method of claim 1, further comprising:
receiving a query for device context information for said first device.

11. The method of claim 1, further comprising:
receiving a query for device context information for said first device and said second device.

12. The method of claim 1, wherein said first device is not registered with said system.

13. The method of claim 1, wherein said device management component includes a presence and availability service.

14. A system, comprising:
an application;
a device management component, said device management component adapted to communicate with a first registered device;
a context management component, said context management component adapted to communicate with a first associated device, with said application regarding said first associated device and said first registered device, and with said device management component regarding said first registered device.

15. The system of claim 14, wherein said application is adapted to send a call to said context management component to configure said first associated device.

16. The system of claim 14, wherein said context management component is adapted to provide device context information for said first associated device to said application.

17. The system of claim 14, wherein said context management component is adapted to send device presence information for said first associated device to said device management component.

18. The system of claim 14, wherein said device management component includes a presence and availability service.

19. The system of claim 14, wherein said system operates in a SIP environment and said first associated device is not registered in said SIP environment and said first registered device is registered in said SIP environment.

20. The system of claim 14, wherein said device management component does not see said first associated device.

21. The system of claim 14, wherein said application, said context management component and said device management component operate in a SIP environment and said first registered device is registered in said SIP environment.

22. An article of manufacture comprising:
a computer readable medium having stored thereon instructions which, when executed by a processor, cause said processor to:
configure a first device as an associated device in a system;
receive information regarding a second device from a device management component, said second device being registered with said system; and
maintain information regarding said first device and said second device.

23. An apparatus, comprising:
a processor;
a communication port coupled to said processor and adapted to communicate with at least one device; and
a storage device coupled to said processor and storing instructions adapted to be executed by said processor to:
configure a first device as an associated device in a system;
receive information regarding a second device from a device management component, said second device being registered with said system; and
maintain information regarding said first device and said second device.
